(19) United States
(12) Patent Application Publication
(10) Pub. No.: US 2008/0260048 A1
(43) Pub. Date: Oct. 23, 2008

(54) Transcoder and Method of Transcoding Therefore

(75) Inventors: Arnoldus Werner Johannes Oomen, Eindhoven (NL); Erik Gosuinus Petrus Schuijers, Eindhoven (NL); Marc Willem Theodorus Klein Middelink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/597,885

(22) PCT Filed: Jan. 31, 2005
(86) PCT No.: PCT/IB2005/050394

§ 371 Date: Aug. 10, 2006

(30) Foreign Application Priority Data
Feb. 16, 2004 (EP) 04100607.3

(51) Int. Cl. H04B 1/66

(52) U.S. Cl. 375/241

(57) ABSTRACT

A transcoder comprises a receiver (101) which receives input data representing an encoded signal and comprising first encoding data and first parametric extension data. The encoded data is fed to a decoder (103). The output of the decoder (103) is fed to an encoder (105) which generates second encoded data according to a different encoding protocol or with different encoding parameters. The first parametric extension data is fed to an extension data processor (109) which generates second parametric extension data directly from the first parametric extension data. The second encoded data and the second parametric extension data is combined in an output processor (107) to generate a transcoded signal comprising separately determined parametric extension data. The parametric extension data may be Spectral Band Replication (SBR) or Parametric Stereo (PS) extension data for an audio bitstream. Improved quality and reduced complexity is achieved by the separate transcoding of the parametric extension data.

### FIELD OF THE INVENTION

The invention relates to a transcoder and method of transcoding therefore and in particular to transcoding of audio signals.

### BACKGROUND OF THE INVENTION

In recent years, the distribution and storage of A/V content in digital form has increased substantially. Accordingly, a large number of coding standards and protocols have been developed including for example MPEG-2 audio and video coding.

One of the most widely known coding standards for digital coding of audio signals is the MPEG-1 Layer 3 standard, described in ISO/IEC JTC1/SC29/WG11 MPEG, IS11172-3, Information Technology—Coding of Moving Pictures and Associated Audio for Digital Storage Media at up to about 1.5 Mbit/s, Part 3: Audio, MPEG-1, 1992, generally referred to as MP3. As an example, MP3 allows, a 30 or 40 megabyte digital PCM (Pulse Code Modulation) stereo audio recording of a song to be compressed into e.g. a 3 or 4 megabyte MP3 file. The exact compression rate depends on the desired quality of the MP3 coded audio. Another example of an audio coding standard is AAC (Advanced Audio Coding), described in ISO/IEC JTC1/SC29/WG11 MPEG, IS13818-7, Information Technology—Generic Coding of Moving Pictures and Associated Audio, Part 7:Advanced Audio Coding, 1997.

Audio coding and compression techniques such as MP3 or AAC provide for very bit-rate efficient audio coding which allows audio files of relatively low data size and high quality to be conveniently distributed through data networks including for example the Internet. However, more efficient techniques that may reduce the bandwidth requirement or increase the quality of the coded signals are desirable. For example, the increase in distribution of audio files over the Internet over the last years has resulted in an accumulation of the network load. Furthermore, lower encoding data rates will further reduce the download time.

Consequently, significant research has been undertaken to provide more efficient coding techniques. However, due to the widespread dissemination of existing coding techniques, it is preferable for new techniques to be backwards compatible with one or more of these.

Two technologies which have recently been developed for encoding of audio signals are known as Spectral Band Replication (SBR) and Parametric Stereo (PS) coding. These technologies can be applied on top of any audio coding scheme in a backwards compatible fashion. Specifically, SBR and PS generate enhancement data, which may be used to reduce the bit rate for encoding the audio signal in for example MP3 or AAC format. The enhancement data may be stored in ancillary data sections of the MP3 or AAC data stream thereby allowing conventional decoders to ignore the additional data.

In Parametric Stereo (PS), stereo audio encoding is achieved by encoding only a single mono signal using e.g. MP3 or AAC. In addition, stereo imaging parameters are determined in the encoder and included in the data stream as separate extension data. At the decoder, the mono encoded channel is expanded into stereo channels by processing the mono encoded signal differently for the two channels dependent on the stereo imaging parameters. These parameters consist of Inter-channel Intensity Differences (IID), Inter-channel Time or Phase differences (ITD or IPD) and Inter-channel Cross-Correlations (ICC).

In a Spectral Band Replication (SBR) enhanced encoder, a low frequency band of the audio signal to be encoded is extracted. This low frequency band is subsequently encoded using a suitable encoding technique such as e.g. MP3 or AAC. In addition, the SBR encoder generates high frequency parameters which are included in the data stream as enhancement data. Thus, the high frequency band of the audio signal is not encoded in the same fashion as the low frequency band but is parametrically encoded. Specifically, the high band is created by a transposition of the low frequency band together with high frequency parameters which comprise data indicating how the transposed signal should be processed (e.g. by envelope modification) to generate the high frequency band. An SBR decoder extracts the high frequency parameters and generates the high frequency band by modifying the transposed low frequency band according to these high frequency parameters. Specifically the SBR high frequency parameters include the following information:
Transposition information (i.e. information indicating the mapping between low frequency band sub-bands and high frequency band sub-bands).
Spectral envelope data The spectral envelope data indicates the energy values of the sub-bands after SBR processing.
Noise floor data. The noise floor data together with the estimated energy of the transposed signal (this estimate is calculated in the SBR decoder) indicates the amount of noise that is to be added to a high band signal.
Optionally, information on absent high frequency components (e.g. harmonics which are present in high band, but not in the low band).

An MP3 encoder with an SBR enhancement is known as an mp3PRO encoder and an AAC encoder with an SBR enhancement is known as an aacPlus or High Efficiency (HE)-AAC encoder.

For both SBR and PS the enhancement parameters can be efficiently encoded into the ancillary data portion of the core-coding scheme as long as the data rate of the enhancement parameters does not exceed the available capacity of the ancillary data sections. Legacy decoders will not process this ancillary data but will only decode the core-encoded data. For SBR this is a band limited signal and for PS a full band monaural signal. In this way backwards compatibility is maintained as audio signals, albeit at reduced quality, may be generated by legacy decoders.

Due to the variety of different coding standards and technologies, it is frequently convenient to transcode between different coding standards or different coding settings of the same coding standard. Thus, transcoding is used to convert a bit-stream of format A to the same format A with different coding parameters (e.g. bit-rate, sampling rate) or to a different format B. Conventionally, a transcoder implements a cascade of a decoder and an encoder such that the incoming signal is first decoded according to the format of the input data and subsequently re-encoded according to the format of the output data stream.

Generally, this will result in a quality loss. The issue of transcoding is further complicated when coding schemes are combined with parametric extensions such as SBR and/or PS. Since these extensions represent parts of the signal in a parameterized form, compared to representing the waveform as faithfully as possible, larger quality degradations are expected as a result of transcoding.

Furthermore, the complexity of the transcoding may increase due to the parametric extensions as the decoder must process the incoming extension data and the encoder must generate new extension data. This may result in e.g. increased cost, computational requirement, delay etc.

Hence, an improved transcoding would be advantageous and in particular a transcoding providing improved performance, increased quality, reduced data rate and/or reduced complexity would be advantageous.

### SUMMARY OF THE INVENTION

Accordingly, the Invention preferably seeks to mitigate, alleviate or eliminate one or more of the above mentioned disadvantages singly or in any combination.

According to a first aspect of the invention, there is provided a transcoder comprising: means for receiving input data representing an encoded signal and comprising first parametric extension data; means for determining second parametric extension data from the first parametric extension data; and means for generating transcoded data including the second parametric extension data.

The inventors of the current invention have realized that parametric extension data for transcoded data may be directly generated from parametric extension data of the input data. The invention may accordingly provide for an improved processing of parametric extension data in a transcoder without requiring that the parametric extension data is included in a decoding and re-encoding process. The invention may accordingly allow a reduced complexity of the transcoder. Alternatively or additionally, the transcoder may provide improved quality of the transcoded data as parametric extension data of improved quality may be determined, and as quality reduction associated with a decoding and re-encoding process may be mitigated or obviated.

The parametric extension data may comprise parameter data which may be used by a parametric decoder to enhance the quality of an encoded signal. Parametric extension data may for audio coding represent parameters according to an audio signal source model that describes the complete or a specific part of an audio signal.

For example, the first and/or second parametric extension data may correspond to extension data of e.g. a Spectral Band Replication (SBR) process and may for example include transposition information, spectral envelope data and/or noise floor data. As another example, the first and/or second parametric extension data may correspond to extension data of e.g. a Parametric Stereo (PS) process and may for example include Inter-channel Intensity Differences (IID) data, Inter-channel Time or Phase differences (ITD or IPD) data and/or Inter-channel Cross-Correlation (ICC) data. As a third example, the first and/or second parametric extension data may correspond to spatial multi-channel extension data. For example, the encoded signal may be a backwards compatible stereo signal and the parametric extension data may comprise data which allows generation of further spatial channels, such as for example center and rear channels.

The input data may be an input data stream and the transcoded data may be a transcoded data stream.

According to a feature of the invention, the input data further comprises first encoding data associated with the encoded signal and the transcoder further comprises: means for transcoding the first encoding data to generate second encoding data; and the means for generating is operable to generate the transcoded data by combining the second encoding data and the second parametric extension data.

The first encoding data may be encoded according to a first encoding standard and may comprise sufficient information to allow independent decoding based only on the first encoding data. The first parametric extension data may be enhancement data which may be used by a suitable decoder to enhance the encoded signal. The first encoded data and the parametric extension data may be separately transcoded thereby allowing individual optimization of the transcoding processes and thus improved performance and/or reduced complexity.

According to a different feature of the invention, the means for determining is operable to determine at least some of the second parametric data by copying at least some data values of the first parametric extension data. This may result in a low complexity implementation and/or may increase the quality of the transcoded data stream. In particular, copying of at least some data values may prevent any transcoding effects to be introduced to these data values.

According to a different feature of the invention, the means for determining comprises means for quantizing data values of the second parametric extension data. The means for determining may re-quantize data values as appropriate for the transcoded data stream. For example, the bit rate may be reduced by using a different (e.g. coarser) quantization for at least one data value of the second parametric extension data than is used for the first parametric extension data. The re-quantization may be applied to data values which are copied from the first parametric extension data to the second parametric extension data or may e.g. be applied to data values derived from the first parametric extension data, for example by interpolation.

According to a different feature of the invention, the means for determining comprises means for encoding data values of the second parametric extension data. The means for determining may re-encode data values as appropriate for the transcoded data stream. The re-encoding may be applied to data values which are copied from the first parametric extension data to the second parametric extension data or may e.g. be applied to data values derived from the first parametric extension data, for example by interpolation.

According to a different feature of the invention, the means for determining is operable to determine at least some of the second parametric data by interpolation between parametric extension data values of the first parametric extension data. This provides for a low complexity means of determining second parametric extension data suitable for the transcoded output stream. The term interpolation is herein used to include both interpolation and extrapolation.

According to a different feature of the invention, the means for determining comprises means for determining transient data of the first parametric extension data and generating the second parametric extension data in response to the transient data .The determined transient data may e.g. be a transient data value or may be a transient data position. This may provide improved quality of the transcoded data and may specifically result in a closer correspondence between the encoded signal and the transcoded output stream. Transient data values may be included in the input data corresponding to sudden changes in the encoded signal. Specifically, the first parametric extension data may comprise regular, substantially periodically occurring data values in addition to transient values occurring at random intervals dependent on the characteristics of the encoded signal. The transient values may e.g. used to calculate data values to be included in the second parametric extension data, for example by interpolation.

According to a different feature of the invention, the means for determining is operable to include at least one transient data parameter in the second parametric extension data. This allows the information comprised in a transient value to be retained in the transcoded data resulting in improved quality and/or may provide for a low complexity transcoding of parametric extension data comprising transient values.

According to a different feature of the invention, the means for determining comprises means for filtering the first parametric extension data prior to determining the second parametric extension data. This may improve the quality of the transcoded data and may specifically improve high frequency performance by compensating for low pass filtering associated with interpolation operations.

According to a different feature of the invention, the input data and transcoded data have non-synchronous frame structures and the means for determining the second parametric extension data is operable to determine at least one data value associated with a frame of the transcoded data in response to a first data value of a first frame of the first parametric extension data and a second data value of a second frame of the first parametric extension data. This provides for a low complexity, efficient and/or high quality transcoding between encoding formats having non-synchronous frame structures. The non-synchronous frame structures of the input data and the transcoded data may specifically have different frame lengths.

According to a different feature of the invention, the means for determining is operable determine the at least one data value by interpolating between the first data value and the second data value. This provides for a low complexity means of determining second parametric extension data suitable for the transcoded output stream. The term interpolation is herein used to include both interpolation and extrapolation.

According to a different feature of the invention, the first data value comprises a plurality of sub-values related to a first plurality of frequency sub-bands, the second data value comprises a plurality of sub-values related to a second plurality of frequency sub-bands and the means for determining is operable to determine the at least one data value to comprise a plurality of sub-values related to a third plurality of frequency sub-bands. This provides for a low complexity means of determining second parametric extension data suitable for the transcoded output stream.

According to a different feature of the invention, the first, second and third plurality of sub-bands comprise the same number of frequency sub-bands. This provides for a low complexity means of determining second parametric extension data suitable for the transcoded output stream.

According to a different feature of the invention, the first plurality of sub-bands comprise more frequency sub-bands than the second plurality of sub-bands and third plurality of sub-bands comprise the same number of frequency sub-bands as the first plurality of sub-bands. This provides for a low complexity means of determining second parametric extension data suitable for the transcoded output stream.

The first and/or second parametric extension data may comprise Spectral Band Replication (SBR) parametric extension data and/or Parametric Stereo (PS) parametric extension data.

According to a different feature of the invention, the parametric extension data is included in an auxiliary data section of the transcoded bit stream. This may provide for backwards compatibility. Legacy decoders that are not capable of exploiting the parametric extension data may still decode the transcoded bit stream by ignoring the auxiliary (or ancillary) data sections.

Preferably, the encoded signal is an audio signal.

According to a second aspect of the invention, there is provided a method of transcoding comprising the steps of: receiving input data representing an encoded signal and comprising first parametric extension data; determining second parametric extension data from the first parametric extension data; and generating transcoded data including the second parametric extension data.

These and other aspects, features and advantages of the invention will be apparent from and elucidated with reference to the embodiment(s) described hereinafter.

### BRIEF DESCRIPTION OF THE DRAWINGS

An embodiment of the invention will be described, by way of example only, with reference to the drawings, in which

FIG. 1 illustrates a block diagram of a transcoder in accordance with an embodiment of the invention;

FIG. 2 illustrates interpolation of data values of parametric extension data in accordance with an embodiment of the invention;

FIG. 3 illustrates interpolation of data values of parametric extension data in accordance with an embodiment of the invention;

FIG. 4 illustrates a principle diagram of a linear interpolator in accordance with an embodiment of the invention;

FIG. 5 illustrates the frequency response of a filter of a linear interpolator in accordance with an embodiment of the invention;

FIG. 6 illustrates an example time alignment between an mp3PRO input stream and an aacPlus transcoded data stream;

FIG. 7 illustrates an example of timing of envelope data values of an input data stream; and

FIG. 8 illustrates another example of timing of envelope data values of an input data stream.

### DESCRIPTION OF PREFERRED EMBODIMENTS

The following description focuses on embodiments of the invention applicable to an audio transcoder and in particular to an audio transcoder for transcoding between input and output signals comprising Spectral Band Replication (SBR) or Parametric Stereo (PS) parametric extension data. However, it will be appreciated that the invention is not limited to these embodiments but may be applied to many other transcoders and extension data.

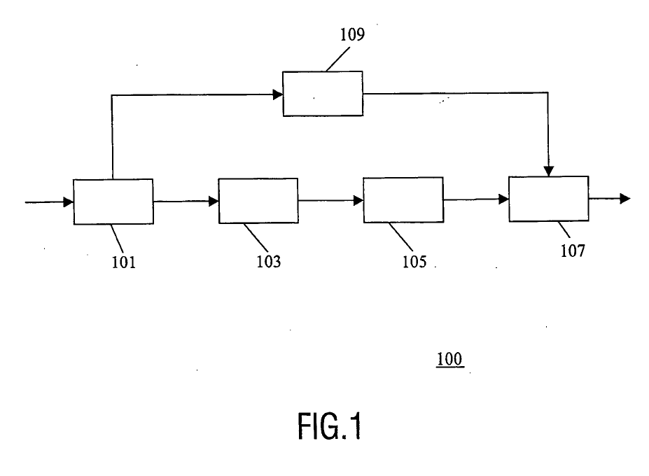

FIG. 1 illustrates a block diagram of a transcoder 100 in accordance with an embodiment of the invention.

In accordance with the embodiment, quality degradations associated with the transcoding of parametric extension data may be mitigated or obviated by directly generating parametric extension data for output transcoded data from the parametric extension data of the input data. In the specific embodiment, the input data further comprises encoding data corresponding to a signal encoded in accordance with a given encoding protocol. In the embodiment, the parametric extension data is enhancement data which may be used by suitable encoders to improve the quality of the decoded signal. For example, the encoding data may comprise a signal encoded in accordance with an audio encoding standard such as MP3 or AAC and the parametric extension data may comprise SBR and/or PS enhancement data.

Specifically, the transcoder 100 comprises a receiver 101 which receives an input data stream comprising an encoded signal and parametric extension data. The receiver 101 is operable to de-multiplex the input data stream and to separate the input encoded data from the input parametric extension data.

The receiver 101 is coupled to a decoder 103 which is fed the input encoded data. In the embodiment, the decoder 103 decodes the input encoded data in accordance with. the appropriate encoding standard and generates a pulse code modulated representation of the underlying audio signal.

The decoder 103 is coupled to an encoder 105 which receives the pulse code modulated data and encodes the signal to generate output encoded data. The encoding protocol or standard of the encoder 105 is in the embodiment different than the encoding protocol of the input encoded data. For example, the input signal may be encoded according to the MP3 encoding standard and the encoder 105 may operate in accordance with the AAC standard.

In some embodiments, the same encoding protocol or standard may be used with different encoding parameters. For example, the encoder 105 may use the same encoding standard but at a different bit rate than the decoder 103.

The decoder 105 is coupled to an output processor 107 which is fed the output encoded data The output processor 107 includes the encoded data in a transcoded data stream.

The receiver 101 is furthermore coupled to an extension data processor 109 which is fed the input parametric extension data. The extension data processor 109 determines output parametric extension data from the input parametric extension data. The output parametric extension data is generated to be compatible with and suitable as parametric extension data for the output encoded data.

The extension data processor 109 is coupled to the output processor 107 which is fed the output parametric extension data. The output processor 107 includes the output parametric extension data in the transcoded data stream.

Thus, in the described embodiment, an encoded signal is transcoded by suing a conventional cascade of an encoder and a transcoder. In addition, parametric extension data of the input data is separately processed to generate suitable parametric extension data for the output data stream. Accordingly, the parametric extension data may be optimally processed allowing increased quality of the transcoded data stream. Furthermore, a lower complexity transcoder may typically be implemented as the processing required for the generation of output parametric extension data is typically relatively simple and as the decoder and encoder can ignore the parametric extension data.

In a simple embodiment, where the frame lengths of the input data stream and the output data stream align, data may typically be copied directly from the input parametric extension data to the output parametric extension data. For example, transcoding of an MP3 data stream at a first bit rate comprising PS extension data to another MP3 data stream at a different bit rate may be achieved by transcoding the MP3 data by the decoder and encoder and directly copying the PS extension data from the ancillary (or auxiliary) data sections of the input stream to the ancillary (or auxiliary) data sections of the output data stream.

The extension data processor 109 may in some embodiments comprise functionality for re-encoding and/or re-quantizing data values of the output parametric extension data. For example, data values for Inter-channel Intensity Differences may be quantized with a coarser quantization in order to reduce the data rate of the PS parametric extension data. Similarly a different encoding of the data values may be used to provide a desired characteristic such as for example a higher error resistance.

Typically, quantization and encoding of data values of the output parametric extension data is particularly advantageous when the data values have been derived by calculations based on the data values of the input parametric extension data.

It will be appreciated that in some embodiments, only the parametric extension data may be modified by the transcoder. For example, the transcoding may extract parametric extension data from the ancillary data sections of a bit stream, modify the parametric extension data according to a given algorithm and re-insert the modified parametric extension data in the ancillary data sections.

In some embodiments, where the frame lengths of the input and output data streams do not align, data values of the output parametric extension data may be determined by interpolation (including extrapolation) from the data values of the input parametric extension data This approach is suitable for most parametric extension data parameters, as these tend to be slowly varying with time.

The following description will describe such an embodiment in more detail with specific reference to Interchannel Intensity Difference data values but it will be appreciated the same principles may be applied to many other parameters.

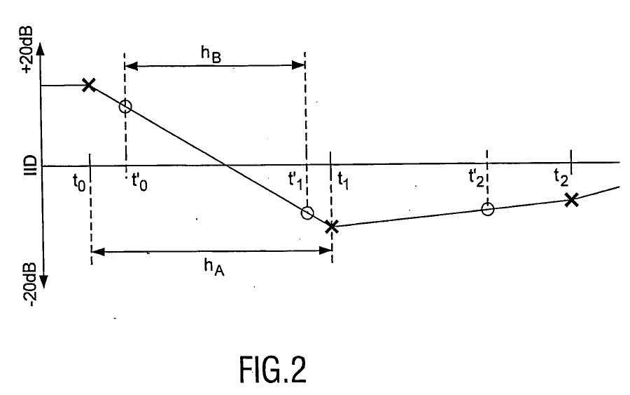

FIG. 2 illustrates interpolation of data values of parametric extension data in accordance with an embodiment of the invention.

In the example, the input parametric extension data comprises an IID value for substantially regular time intervals of hₐ (i.e. with a hop-size (or frame size) of hₐ. The IID values of the input parametric extension data are indicated by crosses in FIG. 2, which specifically shows three IID values of the input parametric extension data at time intervals t₀, t₁ and t₂.

In the example, the output parametric extension data is required to comprise IID values at substantially regular time intervals of h_{b} which are less than hₐ (i.e. with a smaller hop-size (or frame size) of h_{b}). The IID values of the input parametric extension data are indicated by circles in FIG. 2, which specifically shows three IID values of the output parametric extension data at time intervals t′₀, t′₁ and t′₂.

In the embodiment, the extension data processor 109 is operable to generate the output IID values by interpolation. Specifically, as illustrated in FIG. 2, the output IID values are generated by a simple linear interpolation between surrounding input IID values. Thus, the output IID values at t′₀ and t′₁ are generated from the input IID values at t₀ and t₁ and the output IID value at t′₂ is generated from the input IID values at t₁ and t₂.

It will be appreciated that instead of linear interpolation other forms of interpolation or extrapolation may be used.

In some parametric audio coding schemes, additional parametric extension data parameters are generated at transient positions. For example PS parametric extension data typically comprises IID data values at substantially regular intervals as well as transient

IID values which are included when significant and fast transitions are detected in the IID signal.

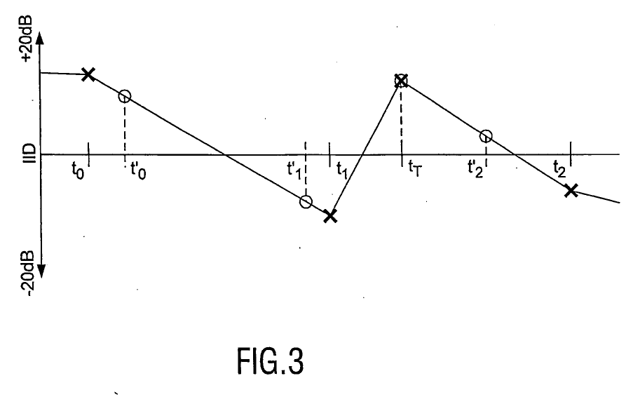

FIG. 3 illustrates interpolation of data values of parametric extension data in accordance with an embodiment of the invention. The example of FIG. 3 corresponds to the example of FIG. 2 except that an additional transient IID value is included in the input parametric extension data at time instant t_{T}.

In order to retain the information contained in the IID value at t_{T}, the extension data processor 109 is operable to generate an additional transient output IID value at t_{T}. Specifically, the extension data processor 109 directly copies the IID value at t_{T} to the second parametric extension data.

In addition, the transient input IID value is used for interpolation when appropriate. Thus, as illustrated in FIG. 3, the output IID value at t′₂ is now generated from the input IID values at t_{T} and t₂.

Linear interpolation results in a low pass filtering of the underlying signal such that quickly varying parameters are smoothed. For PS IID parameters this will result in a narrowed stereo image. In order to compensate for this effect, the IID parameters may be filtered before they are quantized.

A specific example wherein the PS extension data of an MP3(PRO)+PS bit-stream is translated to PS extension data of an aac(Plus)+PS bit-stream is described below. Typical hop-sizes at a sampling frequency of 44.1 kHz for the PS parameters of these bit-streams is 1152 samples (2 granules or 1 frame of MP3 data) and 1024 samples (1 frame of AAC data) respectively.

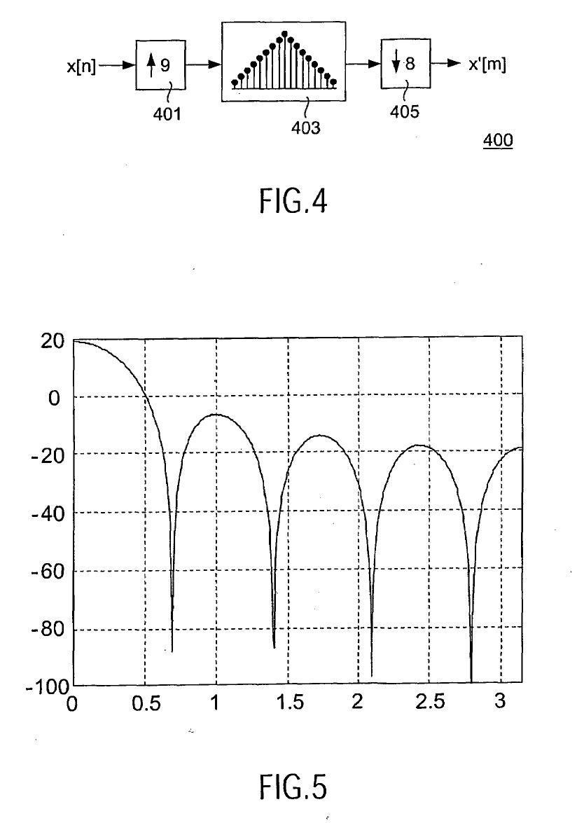

The PS parameter translation using linear interpolation can be interpreted as shown in FIG. 4. FIG. 4 illustrates a principle diagram of a linear interpolator 400.

The linear interpolator 401 comprises an upsampler 401 which upsamples the IID parameters by a factor of 9. The resulting signal is interpolated (filtered) by means of a filter 403 having a triangular impulse response. Finally the signal is down-sampled by a factor of 8 down sampler 405.

FIG. 5 illustrates the frequency response of the filter of FIG. 4. It can clearly be seen that the triangular impulse response results in a low pass filtering.

In order to compensate for the smoothing caused by the linear interpolation the IID values x(n) may be filtered by the following FIR (Finite Impulse Response) filter:

$$y ( n ) = {\sum }_{k = 0}^{K - 1} {a}_{k} x ( n - k )$$

with α preferably being a linear phase impulse response, i.e. αₖ=α_{k′-k-1}. The final IID values that need to be re-quantized may be delay compensated and calculated from:

$$z ( n ) = c \cdot y ( n - \frac{K - 1}{2} )$$

where c is a power-compensation constant that may be set such that the power of z(n) is equal to that of x(n). In the example above, α=[−0.18,1,−0.18] can be used (K=3).

In a more advanced, and thus computationally more expensive embodiment, the actual up and down sampling illustrated in FIG. 4 may be performed and a non-triangular impulse response may be used to further improve the re-sampling reconstruction.

In the following, a specific embodiment wherein the input data and transcoded data have non-synchronous frame structures will be described. Specifically, a transcoder transcoding encoded data from a first encoding protocol to a second encoding protocol having different frame lengths will be described. The description will focus on an embodiment for encoding an MP3 bitstream with SBR extension data (an mp3PRO bitstream) into an AAC bitstream with SBR extension data (aacplus bitstream).

In the embodiment, it is assumed that the bandwidth of the MP3 encoding and the AAC encoding is substantially the same. Specifically, the transcoder may determine the bandwidth of the MP3 encoding from the incoming bitstream and set the AAC encoder to have the same bandwidth.

The envelope and noise floor data values of SBR extension data have constraints related to when and how often they may occur in a frame. An SBR decoder typically performs a sub-band analysis resulting in a number of sub-band samples per core audio frame (e.g. N=18 for mp3PRO and N=32 for aacplus). In order to handle time critical signals, the start border of the first envelope and the stop border of the last envelope in a frame may in mp3PRO and aacPlus vary between [0, 6] (start border first envelope) and [N−1, N−1+6] (stop border last envelope) respectively. Consequently, if N is different for the input encoding protocol and the output encoding protocol, it is not always possible to simply copy the envelope or noise floor data values from the input bitstream to the transcoded bitstream.

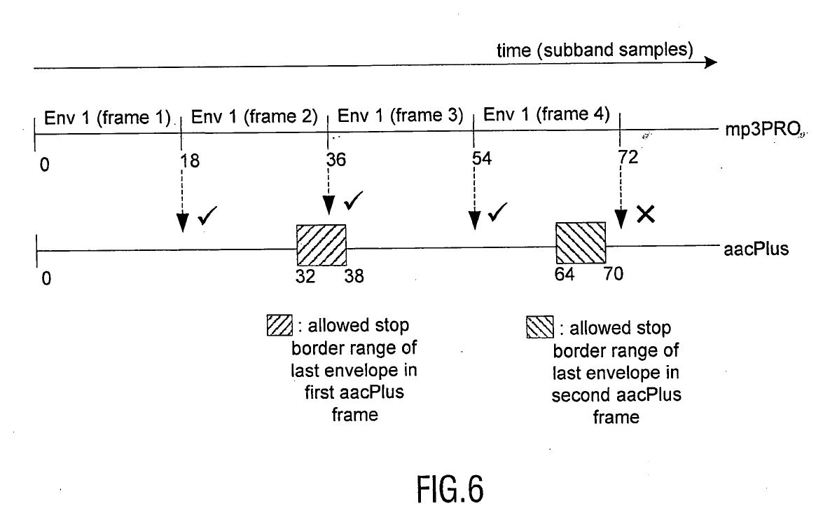

FIG. 6 illustrates an example time alignment for envelope data values between an mp3PRO input stream and an aacPlus transcoded data stream. In the example, it can be seen that envelope data values from mp3PRO frame 1,2 and 3 can be directly copied to corresponding frames of the aacPlus bit stream. However, for the envelope data value of MP3PRO frame 4, some data will relate to one frame of the aacPlus bit stream whereas other data will relate to a different frame of the aacPlus bit stream. Although FIG. 6 specifically illustrates envelope data, it will be appreciated that the principle applies to other data values including noise floor values.

The envelope and noise floor data can simply be copied as long as this does not violate the constraints of the aacPlus bit stream. However, if such a copy is not possible, (parts of) envelope and noise floor data values must be combined into one envelope and noise floor data value.

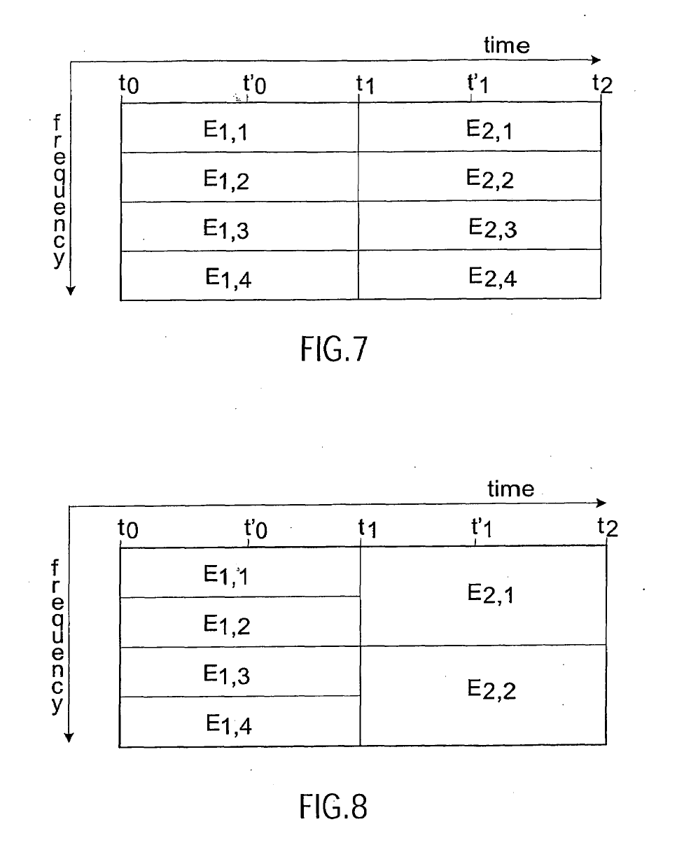

FIG. 7 illustrates an example of a timing of envelope data values of an input data stream. Specifically, FIG. 7 shows two envelope data values of the MP3PRO bitstream. The first envelope data value E₁ covers a time interval from t₀ to t₁ and the second envelope data value E₂ covers a time interval from t₁ to t₂. Each envelope data value E₁, E₂ comprises a number of sub-values E_{1,1}, E_{1,2}, E_{1,3}, E_{1,4}, E_{2,1}, E_{2,2}, E_{2,3}, E_{2,4} each of which in the particular example is a scale factor for a specific frequency band. Thus the number of sub-values depends on the frequency resolution in the frame.

In the example of FIG. 7, the AACPlus transcoded data stream comprises a frame in a time interval t′₁-t′₀ overlapping the two time intervals of the MP3PRO data stream. Accordingly, a new envelope data value must be created for the time interval t′₁-t′₀, and specifically the extension data processor 109 may generate an envelope data value comprising the scale factors determined by interpolation between the scale factors of the envelope data values E₁, E₂, e.g:

$${E}_{1 , 1}^{′} = \frac{( {E}_{1 , 1} \cdot ( {t}_{1} - {t}_{0}^{′} ) ) + ( {E}_{2 , 1} \cdot ( {t}_{1}^{′} - {t}_{1} ) )}{{t}_{1}^{′} - {t}_{0}^{′}} .$$

Similar equations may be applied to generate the other scale factor values E′_{1,2}: E′_{1,2} and E′_{1,2}.

In SBR there are two possible frequency resolutions for envelope data values (the noise floors have only one possible frequency resolution). Accordingly, it can occur that (parts of) envelopes with different frequency resolutions need to be combined. In this case, the extension data processor 109 preferably generates envelope data values according to the highest frequency resolution. This is illustrated with the example shown in FIG. 8.

FIG. 8 shows two envelope data values E₁, E₂ of the MP3PRO bitstream. The example is identical to that of FIG. 7 except that the second envelope data value E₂ comprises only two sub-values E_{2,1}, E_{2,2}. An envelope data value for the time interval t′₁-t′₀ of the AACPlus transcoded data stream may be determined by interpolation according to e.g:

$${E}_{1 , 1}^{′} = \frac{( {E}_{1 , 1} \cdot ( {t}_{1} - {t}_{0}^{′} ) ) + ( \frac{{E}_{2 , 1}}{2} \cdot ( {t}_{1}^{′} - {t}_{1} ) )}{{t}_{1}^{′} - {t}_{0}^{′}}$$

Similar equations may be applied to generate the other scale factor values E′_{1,2}: E′_{1,2} and E′_{1,2}.

It will be appreciated that any suitable extension data may be used. For example, the parametric extension data may be spatial audio coding data. For example, rather than just including stereo image data, a multi-channel image may be parameterized an included in the extension data. In accordance with one such embodiment a stereo encoded signal may be included as a backwards compatible component and the parametric extension data may include data that is able to convert these into a multi-channel representation (e.g. 2 channels to 5 channels). Of course other scenarios are possible, e.g. 1 channel to 5 channels, 2 channels to 4 channels etc.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A transcoder (100) comprising:
means (101) for receiving input data representing an encoded signal and comprising first parametric extension data;
means (109) for determining second parametric extension data from the first parametric extension data; and
means (107) for generating transcoded data including the second parametric extension data.

2. A transcoder as claimed in claim 1 wherein the input data further comprises first encoding data associated with the encoded signal and the transcoder further comprises
means(103, 105) for transcoding the first encoding data to generate second encoding data;
and the means for generating (107) is operable to generate the transcoded data by combining the second encoding data and the second parametric extension data.

3. A transcoder as claimed in claim 1 wherein the means for determining (109) is operable to determine at least some of the second parametric data by copying at least some data values of the first parametric extension data.

4. A transcoder as claimed in claim 1 wherein the means for determining (109) comprises means for quantizing data values of the second parametric extension data.

5. A transcoder as claimed in claim 1 wherein the means for determining (109) comprises means for encoding data values of the second parametric extension data.

6. A transcoder as claimed in claim 1 wherein the means for determining (109) is operable to determine at least some of the second parametric data by interpolation between parametric extension data values of the first parametric extension data.

7. A transcoder as claimed in claim 1 wherein the means for determining (109) comprises means for identifying transient data of the first parametric extension data and for generating the second parametric extension data in response to the transient data.

8. A transcoder as claimed in claim 7 wherein the means for determining (109) is operable to include at least one transient data parameter in the second parametric extension data.

9. A transcoder as claimed in claim 1 the means for determining (109) comprises means for filtering the first parametric extension data prior to determining the second parametric extension data.

10. A transcoder as claimed in claim 1 wherein the input data and transcoded data have non-synchronous frame structures and the means for determining (109) the second parametric extension data is operable to determine at least one data value associated with a frame of the transcoded data in response to a first data value of a first frame of the first parametric extension data and a second data value of a second frame of the first parametric extension data.

11. A transcoder as claimed in claim 10 wherein the means for determining (109) is operable to determine the at least one data value by interpolating between at least the first data value and the second data value.

12. A transcoder as claimed in claim 10 wherein the first data value comprises a plurality of sub-values related to a first plurality of frequency sub-bands, the second data value comprises a plurality of sub-values related to a second plurality of frequency sub-bands and the means for determining (109) is operable to determine the at least one data value to comprise a plurality of sub-values related to a third plurality of frequency sub-bands.

13. A transcoder as claimed in claim 12 wherein the first, second and third plurality of sub-bands comprise the same number of frequency sub-bands.

14. A transcoder as claimed in claim 12 wherein the first plurality of sub-bands comprise more frequency sub-bands than the second plurality of sub-bands and the third plurality of sub-bands comprise the same number of frequency sub-bands as the first plurality of sub-bands.

15. A transcoder as claimed in claim 1 wherein the second parametric extension data is Spectral Band Replication (SBR) parametric extension data

16. A transcoder as claimed in claim 1 wherein the second parametric extension data is Parametric Stereo (PS) parametric extension data.

17. A transcoder as claimed in claim 1 wherein the encoded signal is an audio signal.

18. A method of transcoding comprising the steps of:
receiving input data representing an encoded signal and comprising first parametric extension data;
determining second parametric extension data from the first parametric extension data; and
generating transcoded data including the second parametric extension data.

19. A computer program enabling the carrying out of a method according to claim 18.

20. A record carrier comprising a computer program as claimed in claim 19.
